(19) United States
(12) Patent Application Publication
(10) Pub. No.: US 2011/0116339 A1
(43) Pub. Date: May 19, 2011

(54) DOUGH MIXER AND MIXING BOWL WITH COOLING JACKET FLOW CHANNELS

(76) Inventor: Ankush B. Mittal, Bowling Green, OH (US)

(21) Appl. No.: 12/947,092

(22) Filed: Nov. 16, 2010

Related U.S. Application Data
(60) Provisional application No. 61/262,190, filed on Nov. 18, 2009.

(51) Int. Cl. A21C 1/14

(52) U.S. Cl. 366/97

(57) ABSTRACT

This application relates generally to dough mixers and more particularly to a dough mixer including a mixing bowl with refrigeration/cooling jacket flow channels. Furthermore, the refrigeration/cooling jacket flow channels include curved end portions and/or curved guide vanes which provides for more efficient cooling of the bowl.

### CROSS-REFERENCES

The present application claims the benefit of U.S. Provisional Application Ser. No. 61/262,190, filed Nov. 18, 2009, the entirety of which is incorporated herein by reference.

### TECHNICAL FIELD

This application relates generally to dough mixers and more particularly to a dough mixer including a mixing bowl with refrigeration/cooling jacket flow channels.

### BACKGROUND

Bread dough is often mixed at controlled temperatures (e.g., about 78° F. to about 80° F.). During mixing, friction and viscous shear causes temperature to rise in the dough, which can cause the dough to become sticky and difficult to process.

Mixers are known that utilize cooled mixing components to control temperature of the dough during a mixing process. For example, U.S. Pat. No. 4,275,568 discloses a mixing bowl for a mixer that includes flow passages in a sheet panel through which a cooling fluid passes.

Improvements in mixer bowl cooling systems can increase the efficiency of mixer operation.

### SUMMARY

In an aspect, a dough mixer includes a cabinet and a bowl supported within the cabinet. The bowl includes a bowl body defining an opening through which dough is inserted into the bowl for a mixing operation. An agitator is mounted in the bowl for rotation therein. A refrigeration jacket is mounted to an exterior of the bowl body. The refrigeration jacket includes at least one flow channel arranged in a serpentine configuration. Curved cooling channel end guides and/or curved channel interior or intermediate guide vanes are provided to improve cooling efficiency.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a front view of an embodiment of a mixer;

FIG. 2 is a perspective view of an embodiment of a mixer bowl including refrigeration jacket for use with the mixer of FIG. 1;

FIG. 3 is a section view of the mixer bowl of FIG. 2;

FIG. 4 is a laid-out view of the mixer bowl along line 4-4 of FIG. 3 illustrating coolant flow through the refrigeration jacket;

FIG. 5 is an end view of an embodiment of a channel member for forming the refrigeration jacket for the mixer bowl of FIG. 2;

FIG. 6 illustrates another embodiment of a channel member for forming the refrigeration jacket;

FIG. 7 shows a mixer bowl refrigeration jacket with curved end portions and center guide vanes.

### DETAILED DESCRIPTION

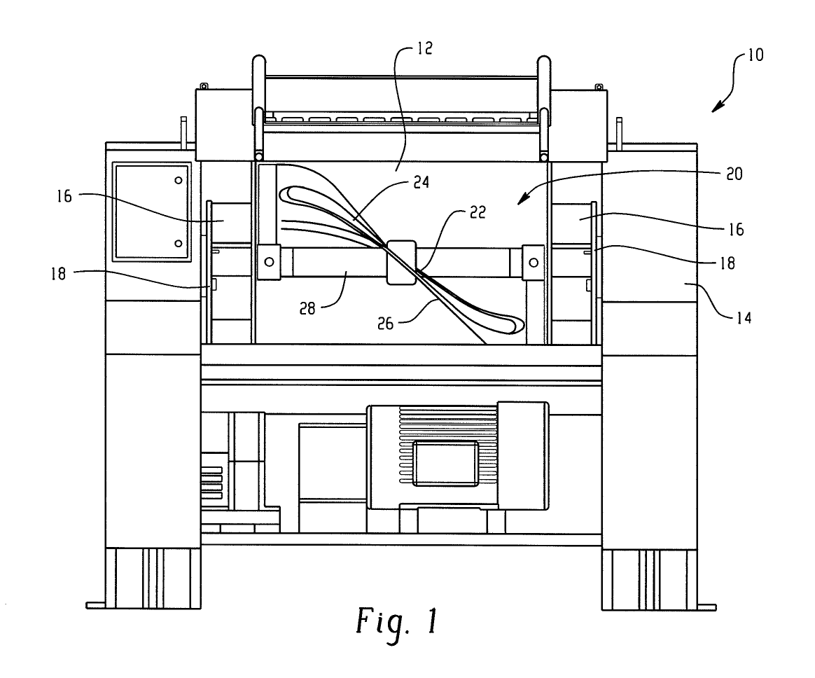

Referring to FIG. 1, a mixer 10 includes a mixing bowl 12 mounted within a cabinet 14. The mixing bowl 12 is an open top 20 arrangement that, in this illustration, is rotated to a sideways position. The mixing bowl 12 is supported at each end by support members 16 that are mounted to a support plate 18. An agitator 22 is rotatably mounted within the mixing bowl 12. The agitator 22 includes a pair of mixing arms 24 and 26 and a rotatable shaft 28 that supports and rotates the mixing arms 24 and 26 during a mixing operation. While agitator 22 is shown by FIG. 1, various agitator assemblies can be utilized including refrigerated agitator assemblies such as that described by U.S. Pat. No. 6,047,558, the details of which are hereby incorporated by reference as if fully set forth herein.

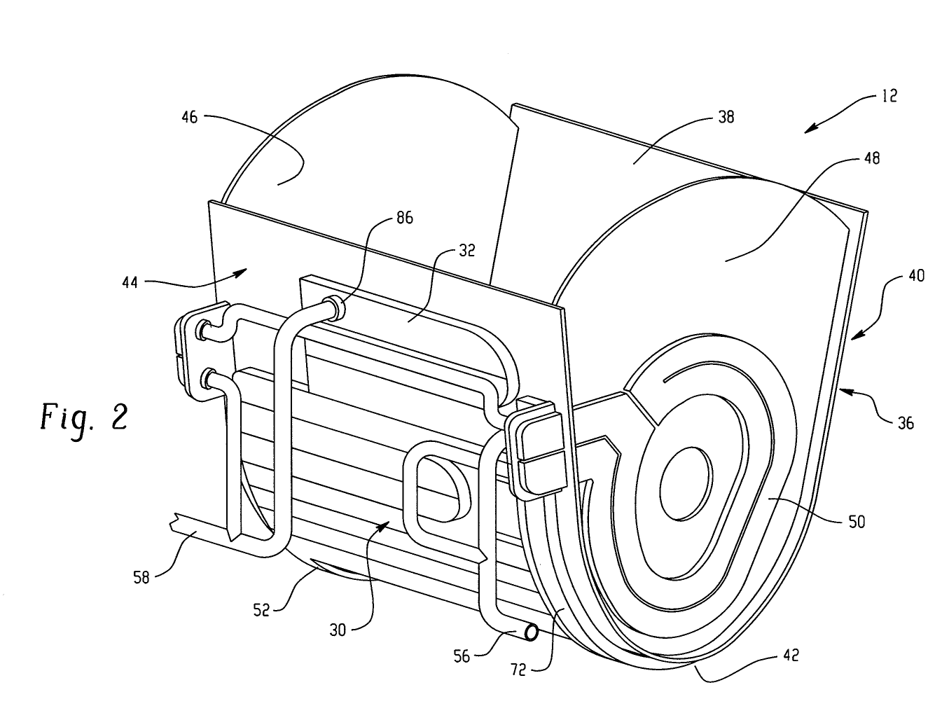

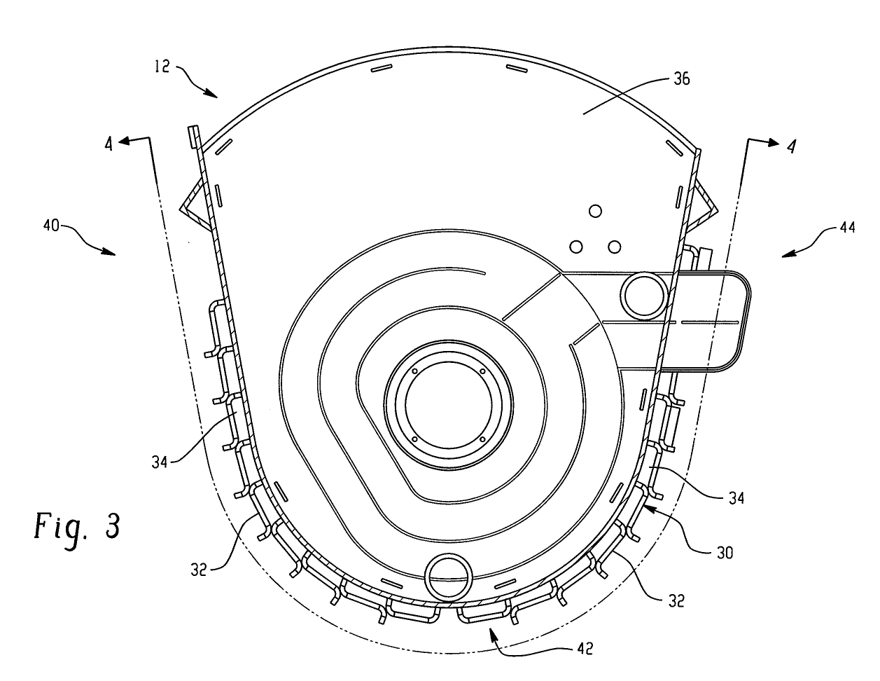

Referring now to FIG. 2, the mixing bowl 12 is provided with a refrigeration jacket 30 on its bowl body 36, which is formed by a plurality of channel members 32 (e.g., formed of stainless steel). The channel members 32 provide flow passages 34 (see FIG. 3) through which a coolant, such as cold water or glycol can travel in order to control or maintain a temperature within the mixing bowl 12 during a mixing operation.

The bowl body 36 includes a U-shaped sheet panel 38 (e.g., formed of stainless steel) that forms a front 40, a bottom 42 and a rear 44 of the bowl 12. Side panels 46 and 48 connect the front 40, bottom 42 and rear 44 of the bowl body 36. The refrigeration jacket 30 extends from the front 40 of the bowl body 36 to the rear 44 of the bowl body. Side channel members 50 are also provided on each of the side panels 46 and 48 so that coolant can also flow along the sides of the bowl body 36. A coolant passage assembly 52 connects the refrigeration jacket 30 to a coolant source (see inlet 56) and also provides an outlet 58 for the coolant exiting the refrigeration jacket. The coolant passage assembly 52 also connects the side channel members 50 to the coolant source.

Referring to FIG. 3, the channel members 32 are aligned side-by-side, extending horizontally along the bowl body 36 and substantially parallel to each other. An outer U-shaped panel can be provided that extends in generally the same direction as the sheet panel 38, overlapping the channel members 32 and providing a space therebetween in which an insulating material (not shown) can be provided. In other embodiments, an outer U-shaped panel may not be provided.

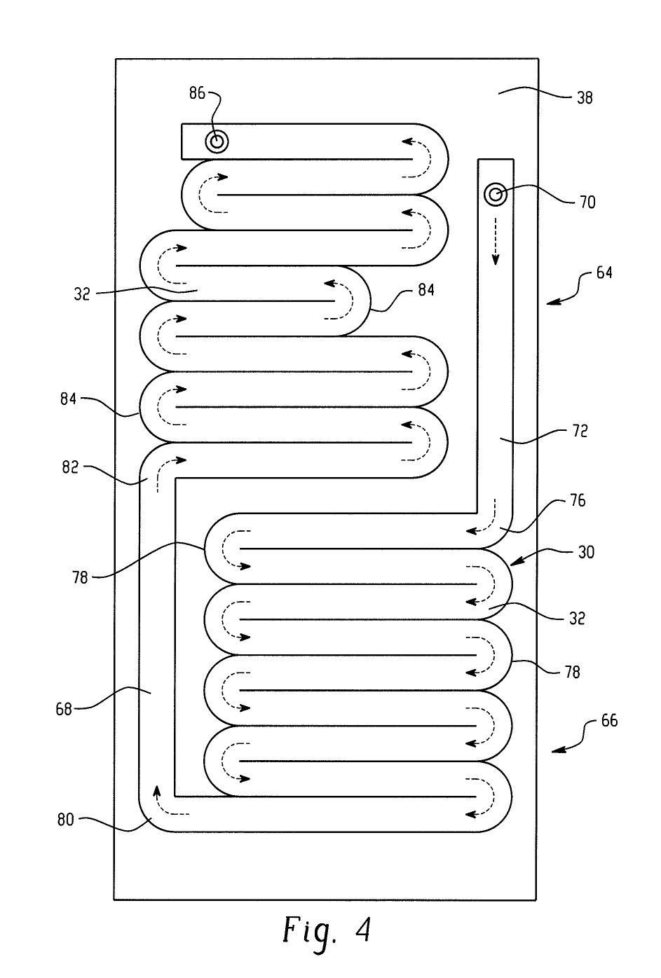

Referring to FIG. 4, the refrigeration jacket 30 provides a first serpentine flow path segment 64 and a second serpentine flow path segment 66 that is connected to the first serpentine flow path segment by a channel member 68 that extends in a front-to-back direction. Coolant enters the refrigeration jacket 30 via a jacket inlet 70 (see also FIG. 2) located at the rear 44 of the bowl body 36 and travels immediately toward the front 40 of the bowl body via another front-to-back extending channel member 72. The coolant then enters the second serpentine flow path segment 66 at entrance 76 and travels along each of the channel members 32 switching direction at the curved end portion 78 of each channel. The coolant then exits the second serpentine flow path segment 66 at exit 80 and flows along the front-to-back channel member 68 to an entrance 82 of the first serpentine flow path segment 64. The coolant then travels along each of the channel members 32 switching direction at the curved end portion 84 of each channel and exits the first serpentine flow path segment 64 at exit 86 (see also FIG. 2). From the exit, the coolant is directed to the outlet 58 of the coolant passage assembly 52.

Flow of coolant through the first and second serpentine flow path segments 64 and 66 cools the sheet panel 38 and is used to refrigerate the internal volume of the bowl 12. The coolant flowing along the first and second flow path segments 64 and 66 leaves the refrigeration jacket 30 before it has been warmed up excessively. In some embodiments, a temperature sensor may be used to monitor temperature of the bowl 12, which can also be used to control the rate of coolant flow through the refrigeration jacket 30. A display may also be provided for indicating temperature to an operator. In other embodiments, a temperature sensor is used to monitor dough temperature and, rather than controlling flow rate, the temperature information is used to turn the refrigeration flow ON or OFF as needed.

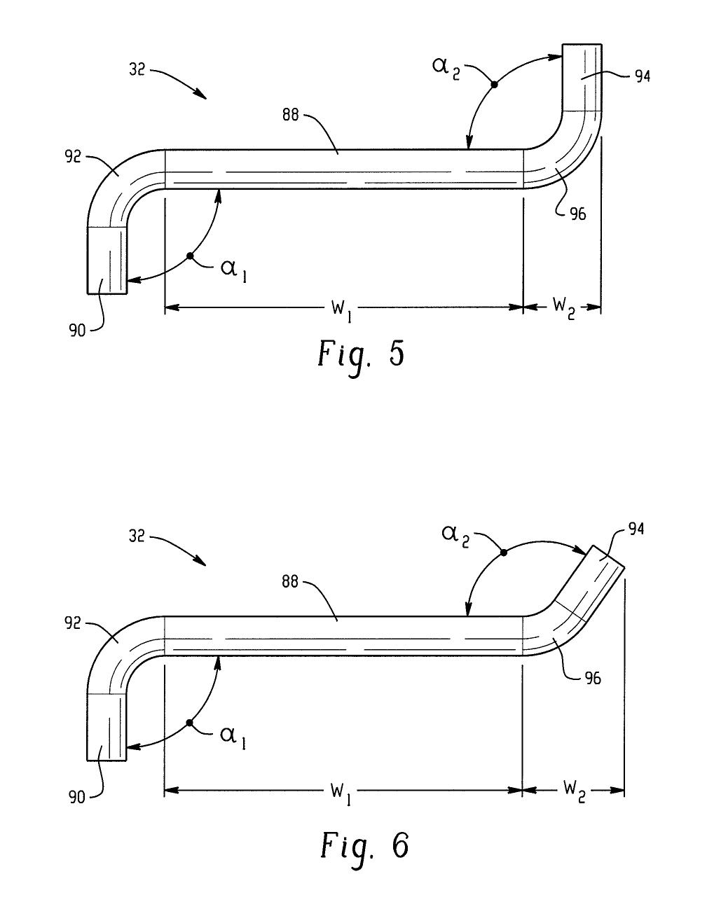

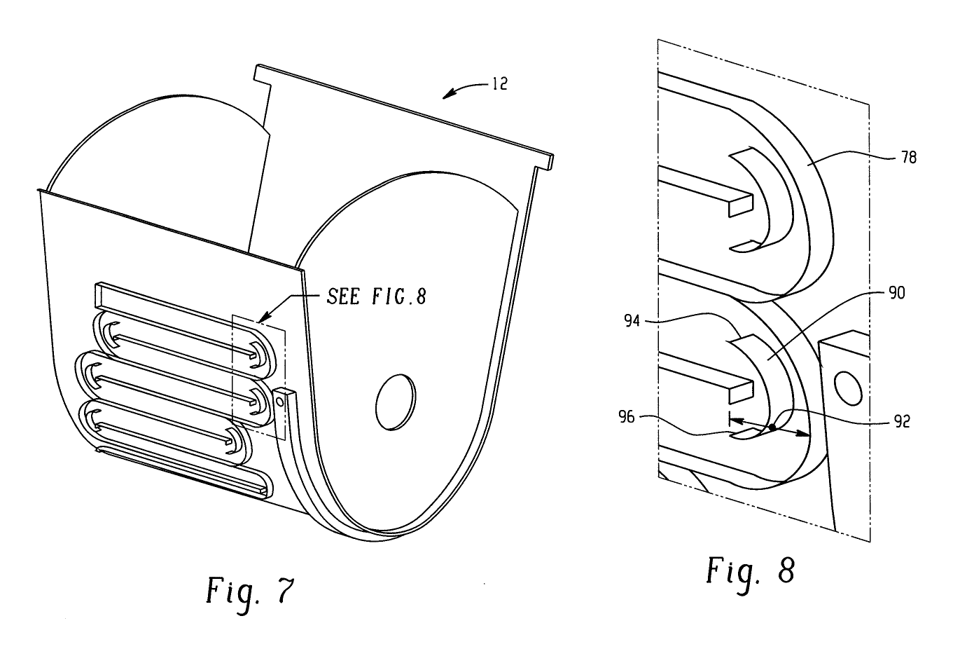

Referring to FIG. 5, the refrigeration jacket 30 is formed of the channel members 32 extending along the bowl body 36 from side-to-side. Each channel member 32 is formed of a unitary plate of sheet material that is formed (e.g., by bending) to include an elongated center panel 88, a first leg 90 connected to the center panel by a first bend 92 and a second leg 94 that is connected to the center panel by a second bend 96. As can be seen, the first bend 92 bends toward the bowl body 36 and the second bend 96 bends away from the bowl body. Additionally, the curvature of the second bend 96 is about the same as that of the first bend 92 such that an angle α₂ is about equal to α₁, where α is measured from the respective leg to the center panel 88 as shown. In some embodiments, α₁ and α₂ are at least about 90 degrees and less than 180 degrees. In some embodiments, such as that shown by FIG. 6, α₂ is different than α₁. In this embodiment, α₂ is greater than α₁.

Referring to FIG. 4 above and the figures described below, the bowl cooling channels include advantageous features that improve both bowl structure and cooling performance. In prior designs, the cooling jackets have a high pressure drop, and many recirculation zones of the travelling coolant, which results in inefficient heat extraction, requiring more refrigeration (ON) time.

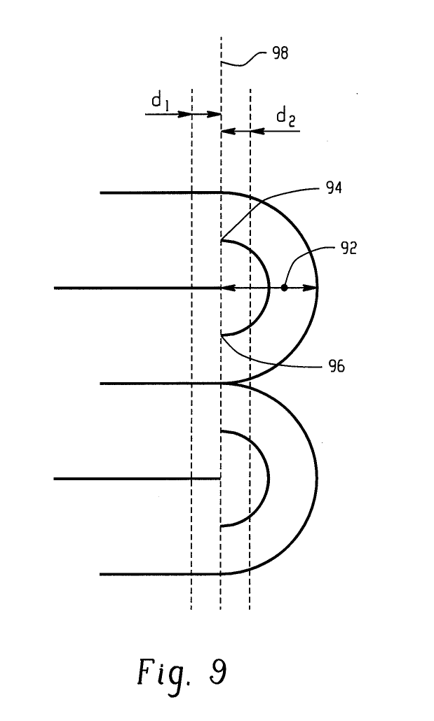

In one embodiment, the bowl cooling channels include curved end portions and/or circular guide vanes in the middle of the slot opening where the coolant passes over to the adjacent channel. As shown in FIGS. 7 and 8, when both the curved end portions and circular guide vanes are present in the bowl cooling channels, the channel end guides and circular guide vanes may be placed co-radial to each other (i.e., are segments having a common center axis).

In one embodiment, the curved end portions 78 are placed as shown in FIG. 4. The location and geometry for the placement of curved end portions 78 shown in FIG. 4 was chosen based on CFD (Computational Fluid Dynamics) analysis on a HS10 mixer bowl model. The design shown in FIG. 4 was based on data collected for the pressure drop, heat extraction capability, temperature gradient, and velocity profile of the coolant flow. The curved end portions 78 create a streamlined flow pattern at a specific flow rate and allowed for the boundary layer formation of the coolant on the jackets and increase the heat extraction capability of the cooling jackets. CFD analysis of the embodiment depicted in FIG. 4 showed increased velocity gradient and reduced pressure drop in the cooling jackets using curved end portions 78 (as compared to embodiments with square end portions).

As described above, coolant follows a serpentine flow path in the cooling jackets of the mixer bowl. This movement of coolant allows for heat extraction from the system. In one embodiment, circular guide vanes 90 are placed in the center of the curved end portions at the end of the jacket profile guiding the coolant to the adjacent channels as shown in FIG. 8. As shown in FIG. 8, the curved end portions 78 and circular guide vanes 90 are co-radial, that is, they form an arc about the same point, but at different distances from this point. In other embodiments, the curvature of the curved end portions and the circular guide vanes may be different. Also, although the circular guide vanes have been shown to be symmetrical, that is, extending an equal amount into the top channel as the bottom channel, other embodiments are possible where either the top or the bottom portion of the circular guide vanes extend further than the corresponding top or bottom. In some embodiments, all of the guide vanes in the cooling jacket have the same shape while in other embodiments, the shapes of the guide vanes may vary within a cooling jacket.

As shown in FIG. 9, the guide vanes are placed at a point along distance 92 between the end of the channel and the curved end portion. In one embodiment, the guide vane is placed at a point on distance 92 which is equidistant from the end of the channel and the curved end portion. In another embodiment, the guide vanes can be slightly offset along the distance 92. Independently from the placement of the guide vanes, the upper 94 and lower 96 ends of the guide vanes are at a range of positions relative to the end of the channel, such that the ends of the guide vanes may be aligned with the end of the channel, shown by line 98, at a distance d1 extending beyond the end of the channel, or at a distance d2 prior to the end of the channel, where d1 can be between about 1 and 2 inches and d2 can be between about 1 and 2 inches. In yet another embodiment, upper end 94 of the guide vane is at a position different from the lower end 96 of the guide vane.

In order to create a design where the velocity gradient was more consistent throughout the cooling channels, a CFD study was conducted using different flow rates, circular guide vane geometries, and locations. The CFD study showed increased velocity gradient in the cooling jackets and reduced pressure drop in the cooling jackets using curved end portions 78 with center guide vanes 90.

Based on the above analysis, the curved end portions and circular guide vanes create a streamlined flow pattern, a continuous velocity profile, a reduced pressure drop, and reduces recirculation of fluid around the jackets. Furthermore, the curved end portions and circular guide vanes streamline the coolant flow to follow a boundary layer on the jackets and reduce the total pressure drop in the system. Based on at least these characteristics, the designs having curved end portions and/or circular guide vanes provides better heat extraction from the mixer dough bowl by maintaining consistent average volume temperature in the cooling jackets and creates turbulence in the flow pattern to allow for consistent heat extraction from the bowl. Thus, these configurations improve the cooling system in dough mixers for extracting heat from the mixed dough batches, which allows a decrease in the refrigeration (ON) time during a dough mixing cycle.

In addition, the embodiments described herein: 1) reduce stress points in the bowl jackets by eliminating corners; 2) reduce refrigeration (ON) time during a dough mixing cycle which improves total dough mixing cycle time; 3) can be incorporated in the current bowl cooling jacket systems; 4) achieve lower dough temperatures, which can provide a more consistent end product by limiting the development of dough during processing; 5) lower energy costs to bakery due to improved efficiency; and 6) can eliminate ice from mixing process, which saves expenses and time.

It is to be clearly understood that the above description is intended by way of illustration and example only and is not intended to be taken by way of limitation, and that changes and modifications are possible. Accordingly, other embodiments are contemplated and modifications and changes could be made without departing from the scope of this application.

What is claimed is:

1. A dough mixer, comprising:
a bowl configured to be supported within a cabinet of the dough mixer, the bowl comprising
a bowl body defining an opening through which dough is inserted into the bowl for a mixing operation;
an agitator mounted in the bowl for rotation therein; and
a refrigeration jacket mounted to an exterior of the bowl body, the refrigeration jacket comprising at least one flow channel arranged in a serpentine configuration, wherein flow direction transition end portions of the flow channel include a channel end and curved end portions.

2. The dough mixer of claim 1 wherein flow direction transition end portions of the flow channel include curved guide vanes located in an intermediate part of the channel, wherein the curved guide vanes have an upper and a lower end.

3. The dough mixer of claim 2 wherein the curved guide vanes are located centrally along the channel.

4. The dough mixer of claim 3 wherein the curved end portions are arcuate and the curved guide vanes are arcuate.

5. The dough mixer of claim 4 wherein the curved end portions and the curved guide vanes are co-radial.

6. The dough mixer of claim 2 wherein the curved guide vanes are positioned equidistant from the channel end and the curved end portions.

7. The dough mixer of claim 2 wherein the upper end and the lower end of the curved guide vanes are aligned with the channel end.
